(19) United States
(12) Patent Application Publication
(10) Pub. No.: US 2011/0191238 A1
(43) Pub. Date: Aug. 4, 2011

(54) VARIABLE MERCHANT SETTLEMENT OPTIONS

(75) Inventors: Jason Blackhurst, Charlotte, NC (US); Michael W. Upton, Charlotte, NC (US)

(73) Assignee: BANK OF AMERICA CORPORATION, Charlotte, NC (US)

(21) Appl. No.: 13/013,685

(22) Filed: Jan. 25, 2011

Related U.S. Application Data
(60) Provisional application No. 61/299,698, filed on Jan. 29, 2010.

(51) Int. Cl. G06Q 40/00

(52) U.S. Cl. 705/39

(57) ABSTRACT

Embodiments of the invention provide for offering variable settlement options to merchants. The merchant and/or the financial institution can define settlement rules based on many settlement options, such as settlement time, settlement location, settlement channel, type of product/service associated with the transaction, and the like. Based on the occurrence of a transaction, the transaction parameters, such as settlement time, location and/or channel are determined by applying the settlement rules to the transaction. Accordingly, the transaction is settled according to the determined settlement rules. In alternate embodiments merchant settlement variables, such current financial status, cash flow requirements, credit requirements and the like, are monitored and the variables are applied to the settlement rules to determine the settlement parameters.

### CLAIM OF PRIORITY UNDER 35 U.S.C. §119

The present application for patent claims priority to Provisional Application No. 61/299,698 entitled “Variable Merchant Settlement Options in a Financial Institution-Based Merchant Offer Program” filed Jan. 29, 2010 and assigned to the assignee hereof and hereby expressly incorporated by reference herein.

### FIELD

In general, embodiments of the invention relate to methods, systems, apparatus and computer program products for transaction settlement between financial institutions and merchants and, more particularly, for providing variable settlement options to merchants.

### BACKGROUND

Currently when a transaction occurs, such as a customer making a credit or debit purchase with a merchant, the merchant has minimal control over how payment of the transaction amount will be made by the financial institution to the merchant, referred to herein as settlement. For example, the financial institution, as the payor/settler, typically has control over the time at which settlement occurs. In most instances, merchants desire to have the settlement occur as soon as possible, for example, in real-time with the occurrence of the transaction, while the financial institutions would prefer to incur as much delay in settling as possible. In addition other settlement parameters, such as the location/destination of the settlement and the settlement channel are also configurable at the discretion of the merchant or the financial institution.

A need exists to develop systems, methods, apparatus, computer programs and the like that provide for merchant settlement to occur based on the needs of the merchant. Such a system would provide the merchant the ability to define which settlement options they prefer. In addition, the desired system should be configurable such that settlement can be determined on a transaction-to-transaction basis based on the current needs of the merchant. Moreover, transaction-to-transaction settlement options should provide for transaction type and transaction attributes to be considered when making a determination as what settlement parameters should apply to a specific transaction.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other device), methods, or a combination of the foregoing for offering variable settlement options to merchants. The merchant and/or the financial institution can define settlement rules based on many settlement options, such as settlement time, settlement location, settlement channel, type of product/service associated with the transaction, transaction parameters and the like. Based on the occurrence of a transaction, the transaction parameters, such as settlement time, location and/or channel is determined by applying the settlement rules to the transaction. Accordingly, the transaction is settled according to the determined settlement rules. In alternate embodiments merchant settlement variables, such current financial status, cash flow requirements, credit requirements and the like, are monitored and the variables are applied to the settlement rules to determine the settlement parameters. The settlement options provide the merchant a means of insuring adequate cash flow and financial stability, while the financial institution can vary fees associated with settlement in accordance with settlement options.

A method for transaction settlement between a financial institution and a merchant defines a first embodiment of the invention. The method includes receiving, in computing device memory, one or more settlement rules associated with the merchant. The method further includes receiving, at a computing device, a transaction confirmation that indicates that a transaction has occurred with the merchant. In addition, the method includes determining, via a computing device processor, one or more settlement parameters by applying at least one of the settlement rules to the transaction. Lastly, the method includes settling, via a computing device processor, the transaction with the merchant in accordance with the one or more settlement parameters.

In specific embodiments of the method, the method further includes monitoring, via a computing device processor, one or more settlement variables associated with the merchant. In such embodiments, monitoring may further include monitoring, at a computing device, at least one of the merchant's current financial status, the merchant's current cash flow requirements, the merchant's future cash flow requirements, the merchant's current credit requirements or the merchant's future credit requirements. In such embodiments, determining the one or more settlement parameters further includes determining, via the computing device processor, the one or more settlement parameters by applying at least one of the settlements rules to the transaction. At least one of the applied settlement rules is associated with a monitored settlement variable.

In other specific embodiments of the method, receiving the one or more settlement rules further includes receiving, in the computing device memory, one or more settlement rules associated with the merchant, wherein the settlement rules are received from one of the financial institution or the merchant.

In further specific embodiments of the method, receiving the one or more settlement rules further include receiving, in the computing device memory, a settlement rule associated with one or more of a time for settlement; a settlement location; a settlement channel; a transaction product type; transaction type, such as, transaction amount, transaction payment type, transaction location, transaction customer type or transaction customer; or the like.

In further specific embodiments of the method, determining one or more settlement parameters further comprises determining, via a computing device processor, one or more settlement parameters, wherein the parameters include at least one of settlement time, settlement location or settlement channel.

In still further specific embodiments of the invention, receiving a transaction confirmation further comprises receiving a transaction confirmation associated with a transaction in which the financial institution has authenticated the customer.

An apparatus configured for transaction settlement between a financial institution and a merchant defines second embodiments of the invention. The apparatus includes a computing platform including at least one processor and a memory. The apparatus further includes a merchant settlement application stored in the memory and executable by the processor. The merchant settlement application includes a settlement rules routine configured to receive, in computing device memory, one or more settlement rules associated with the merchant. In addition, the merchant settlement application includes a settlement parameter determining routine configured to determining one or more settlement parameters by applying at least one of the settlement rules to a transaction associated with the merchant. Moreover, the merchant settlement routine includes a settlement routine configured to settle the transaction with the merchant in accordance with the one or more settlement parameters.

In further specific embodiments of the apparatus the merchant settlement application further includes a merchant settlement variable monitoring routine configured to monitor one or more settlement variables associated with the merchant. In such embodiments of the apparatus the merchant settlement variable monitoring routine may be further configured to monitor at least one of the merchant's current financial status, the merchant's current cash flow requirements, the merchant's future cash flow requirements, the merchant's current credit requirements or the merchant's future credit requirements. In such embodiments of the apparatus, settlement parameter determining routine may be further configured to determine the one or more settlement parameters by applying at least one of the settlements rules to the transaction, wherein at least one of the applied settlement rules is associated with a monitored settlement variable.

In other specific embodiments of the apparatus, the settlement rules routine is further configured to receive the one or more settlement rules associated with the merchant, wherein the settlement rules are received from one of the financial institution or the merchant.

In still further specific embodiments of the apparatus, the settlement rules routine is further configured to receive a settlement rule associated with one or more of a time for settlement; a settlement location; a settlement channel; transaction product/service type; transaction type, such as, transaction amount, transaction payment type, transaction location, transaction customer type or transaction customer; or the like.

Moreover, in additional embodiments, the settlement parameter determining routine is further configured to determine one or more settlement parameters. The parameters include at least one of settlement time, settlement location or settlement channel.

A computer program product that includes a non-transitory computer-readable medium provides for third embodiments of the invention. The computer readable-medium includes a first set of codes for causing a computer to receiving one or more settlement rules associated with the merchant. In addition, the computer-readable medium includes a second set of codes for causing a computer to receive a transaction confirmation that indicates that a transaction has occurred with the merchant. In addition, the computer-readable medium includes a third set of codes for causing a computer to determine one or more settlement parameters by applying at least one of the settlement rules to the transaction. Lastly, the computer-readable medium includes a fourth set of codes for settling the transaction with the merchant in accordance with the one or more settlement parameters.

Thus, systems, apparatus, methods, and computer program products herein described provide for variable merchant settlement options for financial transactions associated with a financial institution-based merchant offer program. Thus, the merchant is able to better manage their financial situation, cash flow and the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for providing and implementing variable merchant settlement options, in accordance with present embodiments of the invention;

FIG. 2 provides a more detailed block diagram of an apparatus configured for providing and implementing variable merchant settlement options, in accordance with embodiments of the present invention;

FIG. 3 provides a block diagram illustrating a financial institution apparatus that stores merchant account profiles that include settlement rules, in accordance with embodiments of the present invention;

FIG. 4 provides a flow diagram illustrating a method for receiving and applying settlement rules to a transaction, in accordance with embodiments of the present invention; and

FIG. 5 provides a flow diagram illustrating a method for receiving settlement rules, monitoring settlement variables and applying a settlement rule to a transaction, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments of the present invention provide for systems, devices, apparatus, methods and computer program products for offering variable settlement options to merchants. The merchant and/or the financial institution can define settlement rules based on many settlement options, such as settlement time, settlement location, settlement channel, type of product/service associated with the transaction, transaction parameters and the like. Based on the occurrence of a transaction, the transaction parameters, such as settlement time, location and/or channel are determined by applying the settlement rules to the transaction. According, the transaction is settled according to the determined settlement rules. In alternate embodiments merchant settlement variables, such current financial status, cash flow requirements, credit requirements and the like, are monitored and the variables are applied to the settlement rules to determine the settlement parameters. The settlement options provide the merchant a means of insuring adequate cash flow and financial stability, while the financial institution can vary fees associated with settlement in accordance with settlement options.

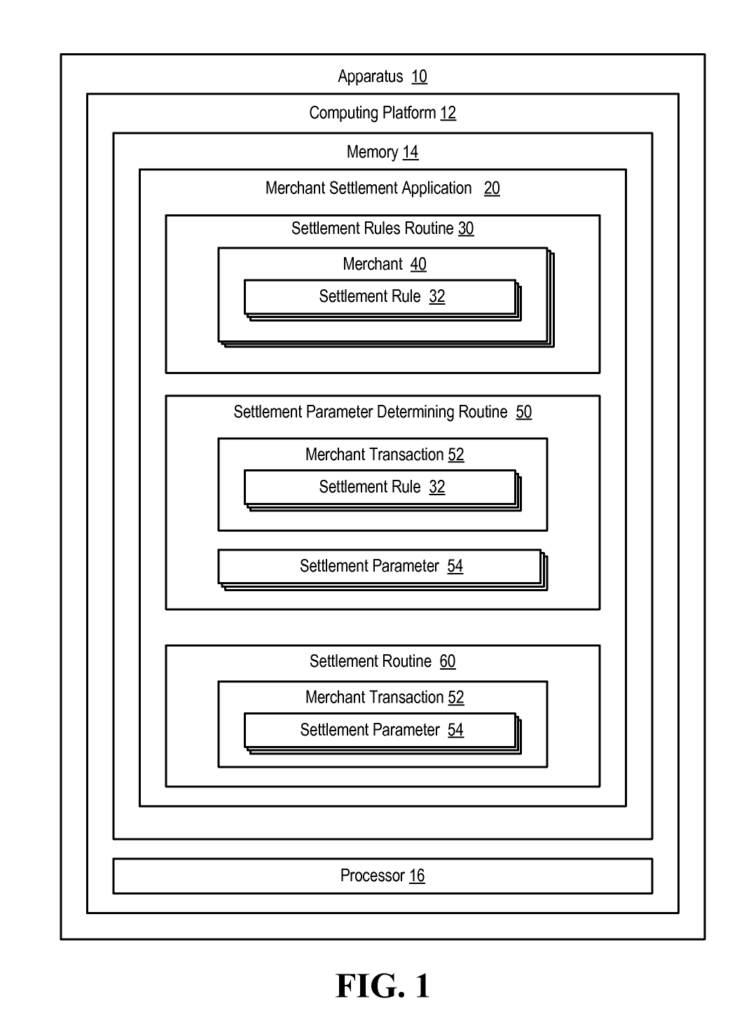

Referring to FIG. 1 a high level block diagram is depicted of an apparatus 10 configured for providing and implementing a variable merchant settlement options, in accordance with embodiments of the present invention. The apparatus 10 includes a computing platform 12 having a memory and at least one processor 16 in communication with the memory 14.

The memory 14 of apparatus 10 includes merchant settlement application 20 that is configured to provide merchants variable settlement options and apply the settlement options to transactions on a transaction-by-transaction basis. The merchant settlement application includes settlement rules routine 30 that is configured to receive one or more settlement rules 21 for one or more of a plurality of merchants 40.

The settlement rules may be received from the financial institution making the settlement payment or received from the merchant. Settlement rules received, i.e., defined by, the financial institution may be based on predetermined settlement arrangements made with the specific merchant or the settlement rules received from the financial institution may apply to multiple merchants, such as specific types of merchants or the like. Settlement rules received, i.e., defined by, the merchant provide for merchant-configurable settlement rules that may be defined, in some embodiments, dynamically, by the merchant based on the merchant's requirements/needs and, in some embodiments of the invention current or dynamic requirements/needs. In those embodiments of the invention in which the settlement rules are received from the merchant, the settlement rules routine 30 may include a merchant interface, such as web page/portal configured to allow for merchant selection or definition of settlement rules.

Settlement rules 32 may apply to characteristics of the settlement, such as the time for settlement, the location of settlement, the channel used for settlement or the like. For example, the merchant may select or define a settlement rule 32 that provides for all settlements to be made in real-time of the transaction, or within a business day of the transaction or the like. If the settlement rule 32 as defined by the merchant varies from the financial institutions conventional practices, the financial institution may charge fees to the merchant in proportion to the variance. For example, in the financial institution's standard practice is settlement within two business days of the transaction, any merchant settlement rule 32 that prescribes settlement in less than two days may warrant a fee.

In addition to settlement rules 32 applicable to characteristics of the settlement, other settlement rules may apply to characteristics of the transactions, such as the product/service associated with the transaction, or the type of transaction, such as transaction amount, transaction payment type, transaction location, customer type (i.e., consumer or business) or the like. The financial institution and/or the merchant can define settlement rules 32 such that the characteristics of the settlement, such as settlement time, settlement location, and/or settlement channel vary based on the product/service associated with the transaction and/or the transaction type. For example, a settlement rule 32 may be defined that provides for certain types of transactions to be settled in real-time, while other transaction types are settled within two business days, or the like.

Thus, merchant settlement application 20 additionally includes settlement parameter determining routine 50 configured to determine one or more settlement parameters 54 by applying the applicable settlement rules 32 to a transaction associated with a merchant 40. The settlement parameters may include, but are not limited to, settlement time, settlement location, settlement channel and the like.

In addition, merchant settlement application 20 includes settlement routine 60 that is configured to settle the transaction with the merchant in accordance with the determined settlement parameters.

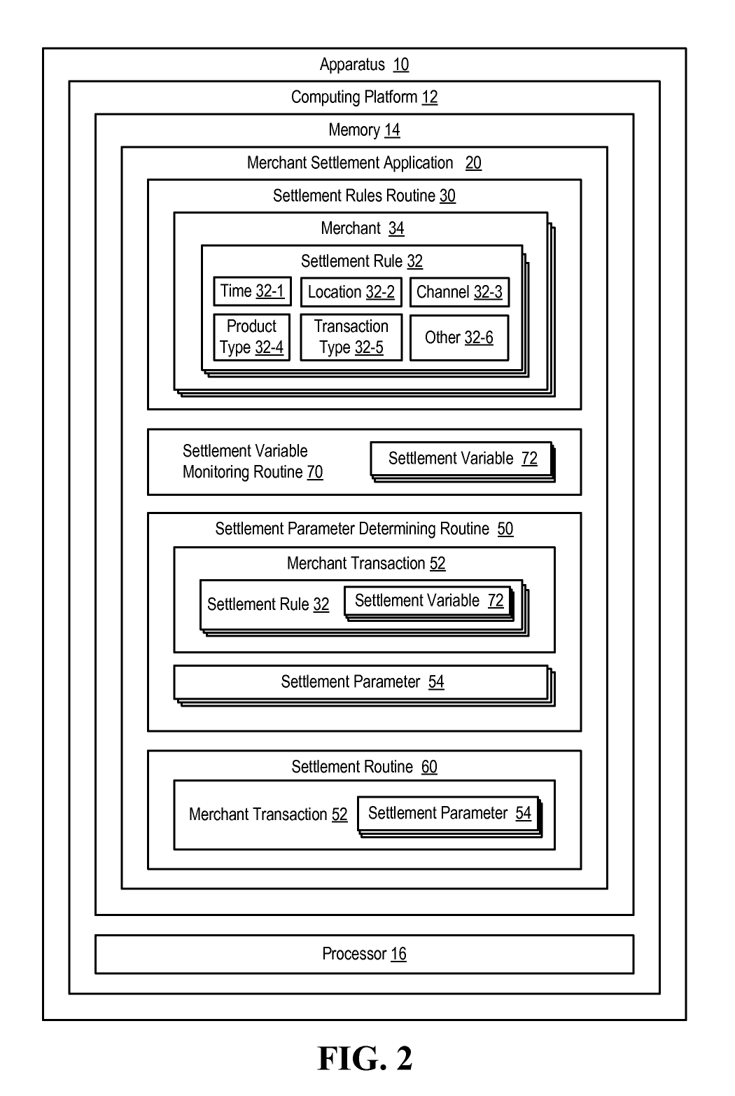

FIG. 2 provides a more detailed block diagram depiction of an apparatus 10 configured for providing and implementing variable merchant settlement options, according to specific embodiments of the invention.

The apparatus 10 includes computing platform 12 that can receive and execute algorithms, such as routines, and applications. The computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) that interfaces with any resident programs, such as merchant settlement application 20 and routines associated therewith or the like stored in the memory 14 of the apparatus 10.

Processor 14 may additionally include various processing subsystems (not shown in FIG. 2) embodied in hardware, firmware, software, and combinations thereof, that enable the functionality of apparatus 10 and the operability of the apparatus on a network. For example, processing subsystems may provide for initiating and maintaining communications and exchanging data with other networked devices. For the disclosed aspects, processing subsystems of processor 16 may include any subsystem used in conjunction with merchant settlement application 20 and related algorithms, sub-algorithms, sub-modules thereof.

As previously discussed, the memory 14 of apparatus 10 is configured to store and the processor 16 is configured to execute merchant settlement application 20. Merchant settlement application 20 is configured to provide merchants with various settlement options and to implement the settlement options.

The merchant settlement application 20 includes settlement rules routine 30 that is configured to receive one or more settlement rules 21 for one or more of a plurality of merchants 40.

Settlement rules 32 may apply to characteristics of the settlement, such as the settlement time 32-1, the settlement location 32-2, settlement channel 32-3 or the like. In addition, settlement rules 32 may apply to transaction product/service type 32-4, transaction type 32-5 or any other characteristic or attribute associated with the settlement or the transaction. As previously noted, transaction type may include, but is not limited to, transaction amount, transaction payment type, transaction location, customer type (i.e., consumer or business) or the like.

Settlement time 32-1 provides for the merchant and/or the financial institution to configure the time between transaction and settlement/payment. For example, the merchant may choose real-time settlement/payment (i.e., payment that occurs substantially at the time of the transaction), same day settlement/payment, three-day settlement/payment, fifteen-day settlement/payment or the like. Based on the time settlement rule 32-1 chosen by the merchant, the financial institution may vary the fees that are charged to the merchant. For example, real-time settlement/payment may incur the highest fees while prolonged (e.g., fifteen-day, thirty-day, etc., settlement/payment) may incur the lowest fees.

Settlement location 32-2 may define at which merchant location settlement/payment is to be made and settlement channel 32-3 may define which electronic form or non-electronic form of settlement is to be used.

Product/service type 32-4 provides for the merchant and/or the financial institution to configure settlement based on the type of product and/or service involved in the transaction. For example, products or services that will be provided on an ongoing basis (e.g., a subscription basis or the like) may provide for different settlement than a product or service that is provided in its entirety at the time of the transaction. In another example, products or services may be classified or otherwise grouped such that products or service of one class/group are configured for settlement/payment in a first manner and products or services of a another class/group are configured for settlement/payment in an second manner. In specific instances, configuring settlement for different product types may be necessary depending on the merchant's payment/settlement obligations to their respective suppliers. Such configuration of settlement may be based on the merchant's current cash flow, financial obligations, payment obligations for secured transactions, and the like.

Transaction type 32-5 provides for the merchant and/or the financial institution to configure settlement based on the type of transaction. The type of transaction may include any identifying criteria associated with the transaction, such as dollar amount, customer payment type, location of transaction (e.g., online versus physical retail location), customer type (i.e., individual or business), customer and/or the like.

In addition other settlement rules 32-6 may be configured by the merchant or the financial institution. Settlement rules 32 may be predetermined by the merchant of financial institution or, in specific embodiments, settlement rules 32 may be dynamically configured for a specific transaction or group of transactions or based on the dynamic needs/requirements of the merchant and/or financial institution.

Additionally, merchant settlement application 20 may include settlement variable monitoring routine 70 operable to monitor one or more settlement variables 72. The settlement variables 72 may be defined by the merchant or the financial institution and may include, but are not limited to, the merchant's current financial situation, the merchant current or future cash flow needs, the merchant's current or future credit needs and the like. In alternate embodiments of the invention, the settlement variable monitoring routine 70 may be external from the merchant settlement application 20. In such embodiments, the monitored settlement variable information is imported or otherwise communicated to the merchant settlement application 20. Settlement variables 72 allow for settlement parameters 54 be defined based on dynamic conditions associated with the merchant, such as current financial situation, current or future credit requirements, current or future cash flow or the like.

In addition, merchant settlement application 20 includes settlement parameter determining routine 50 configured to determine settlement parameters for a merchant based on application of one or more relevant settlement rules 32 to a merchant transaction 52; in accordance with specific embodiments. In specific embodiments, in which merchant variables 72 are determined, one or more of the settlement rules may be associated with a merchant variable. In such embodiment, the merchant variable 72 is applied to the associated settlement rule 32 to determine one or more settlement parameters 54. The settlement parameters 54 may include, but are not limited to, time of settlement/payment, settlement location, settlement channel, settlement currency and the like.

In addition, merchant settlement application 20 includes settlement routine 60 that is configured to settle the transaction with the merchant in accordance with the determined settlement parameters.

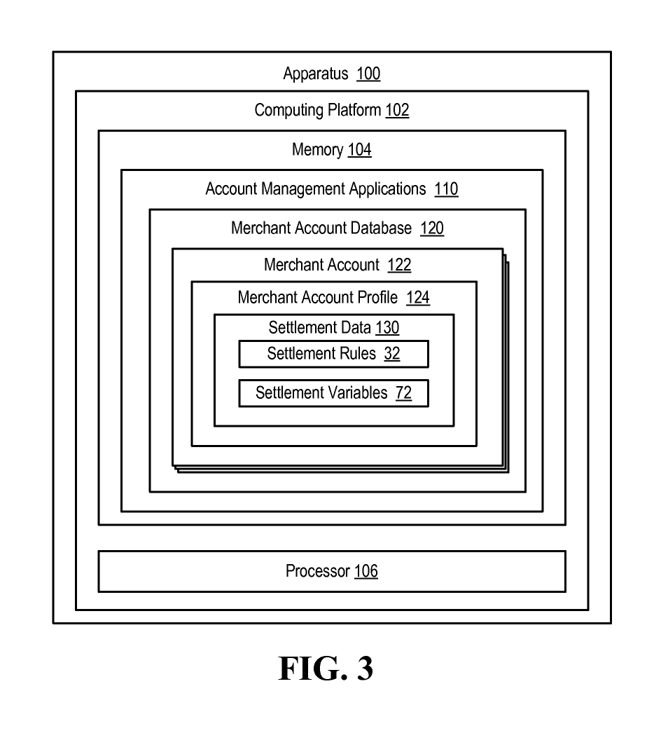

Referring to FIG. 3 a block diagram is depicted of a financial institution apparatus 100 configured for storing merchant account data, including merchant settlement data, in accordance with specific embodiment of the invention.

The apparatus 100, which may comprise one or more computing devices, such as servers or the like, includes a computing platform 102 having at least one processor 106 and a memory 104. The memory 104 stores account management applications 110 including merchant account database 120. Merchant account database includes a plurality of merchant accounts 122. Each merchant account 122 includes a merchant profile 124 that includes merchant specific data related to the merchant. Included in the merchant account profile 124 is settlement data 130. The settlement data includes merchant and/or financial institution-defined settlement rules 32, merchant and/or financial institution-defined settlement variables 72 and/or the like. The settlement rules 32 and/or settlement variables 72 are applied to the settlement parameter determining routines 50 (shown in FIG. 2) to determine settlement parameters for transactions associated with the merchant.

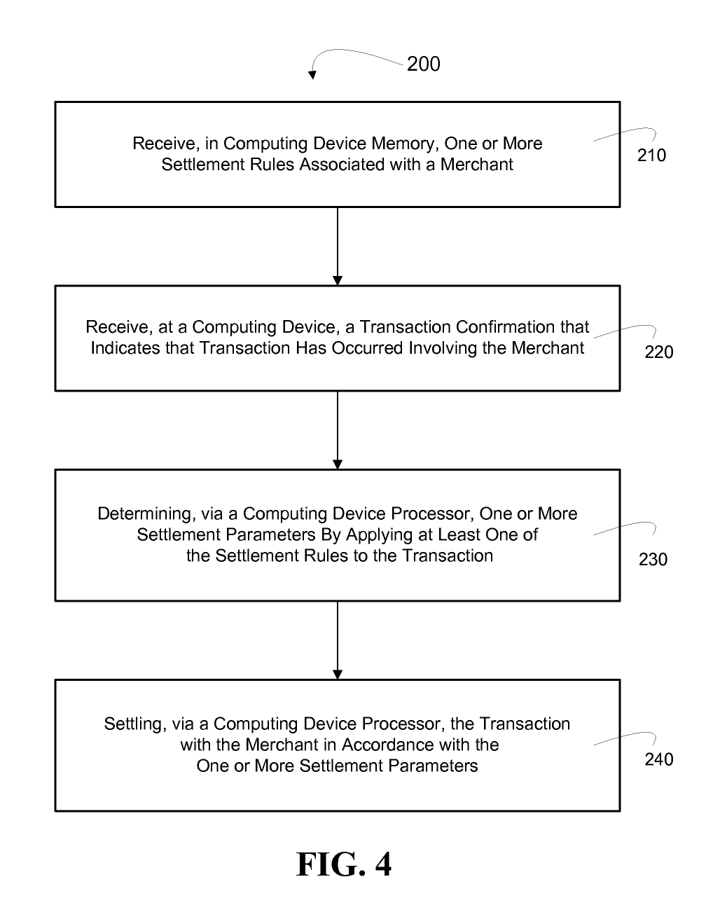

FIG. 4 is a flow diagram of a method 200 for receiving settlement rules and applying the rules to a merchant settlement/payment of transactions associated with the merchant, in accordance with embodiments of the invention. At Event 210, one or more merchant settlement rules associated with a merchant are received at a computing device and stored in memory. As previously described, the settlement rules may be merchant-defined and/or financial institution-defined. The settlement rules may include, but are not limited to, settlement/payment time, settlement location, settlement means, settlement channel, product/service type, transaction type/amount and the like.

At Event 220, a transaction notification is received at a computing device that indicates that a transaction has occurred involving the merchant. As described herein the transaction may occur online, such as via a merchant website or the transaction may occur at the merchant's physical retail location.

At Event 230, notification of the transaction triggers determination of one or more settlement parameters by applying at least one of the settlement rules to the transaction. For example, based on product(s)/service(s) included in the transaction and/or the type/amount of the transaction, time of the transaction or the like, a specific configured settlement rule may be applied to the transaction, such as time for settlement, where payment/settlement is to occur, manner of payment/settlement and the like. At Event 240, the transaction is automatically settled with the merchant in accordance with the one or more determined settlement parameters. For example, in accordance with specific embodiments, payment/settlement occurs within the configured time guidelines set for the transaction and/or the merchant.

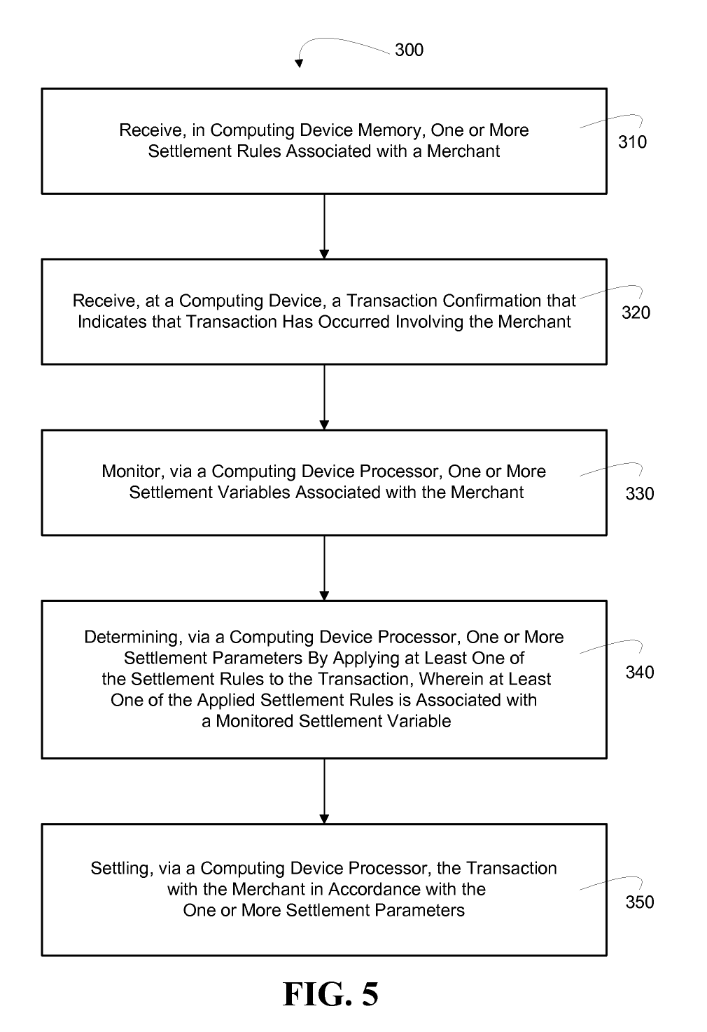

FIG. 5 provides a flow diagram illustration of an alternate method 300 for receiving settlement rules, monitoring settlement variables and applying one or more settlement rules to a merchant transaction based on one or more merchant variables, in accordance with alternate embodiments of the present invention. At Event 310, one or more merchant settlement rules associated with a merchant are received at a computing device and stored in memory. As previously described, the settlement rules may be merchant-defined and/or financial institution-defined. The settlement rules may include, but are not limited to, settlement/payment time, settlement location, settlement means, settlement channel, product/service type, transaction type/amount and the like.

At Event 320, a transaction notification is received at a computing device that indicates that a transaction has occurred involving the merchant. As described herein the transaction may occur online, such as via a merchant website or the transaction may occur at the merchant's physical retail location.

At Event 330, one or more settlement variables associated with the merchant are monitored. The settlement variables may include, but not limited to, the current financial situation of the merchant, such as current or future cash flow needs, current or future credit needs and the like. While the flow of method 300 indicates that the settlement variables are monitored after the receipt of the transaction notification, in practice, the settlement variables are typically monitored on an ongoing basis and are accessed or assessed once the transaction notification is received for application to a transaction rule.

At Event 340, notification of the transaction triggers determination of one or more settlement parameters by applying at least one of the settlement rules to the transaction. In addition at least one of the rules that is applied is associated with a monitored settlement variable For example, if the merchant's current cash flow needs is below a predetermined limit, first settlement options, such as hastened settlement, may apply and the merchant's current cash flow needs are above the predetermined limit, second settlement options may apply. At Event 340, the transaction is automatically settled with the merchant in accordance with the one or more determined settlement parameters. For example, in accordance with specific embodiments, payment/settlement occurs within the configured time guidelines set for the transaction and/or the merchant.

Thus, systems, apparatus, methods, and computer program products herein described provide for offering variable settlement options to merchants. The merchant and/or the financial institution can define settlement rules based on many settlement options, such as settlement time, settlement location, settlement channel, type of product/service associated with the transaction, transaction parameters and the like. Based on the occurrence of a transaction, the transaction parameters, such as settlement time, location and/or channel are determined by applying the settlement rules to the transaction. Accordingly, the transaction is settled according to the determined settlement rules. In alternate embodiments merchant settlement variables, such current financial status, cash flow requirements, credit requirements and the like, are monitored and the variables are applied to the settlement rules to determine the settlement parameters. The settlement options provide the merchant a means of insuring adequate cash flow and financial stability, while the financial institution can vary fees associated with settlement in accordance with settlement options.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for transaction settlement between a financial institution and a merchant, the method comprising:
receiving, in computing device memory, one or more settlement rules associated with the merchant;
receiving, at a computing device, a transaction confirmation that indicates that a transaction has occurred involving the merchant;
determining, via a computing device processor, one or more settlement parameters by applying at least one of the settlement rules to the transaction; and
settling, via a computing device processor, the transaction with the merchant in accordance with the one or more settlement parameters.

2. The method of claim 1, further comprising monitoring, via a computing device processor, one or more settlement variables associated with the merchant.

3. The method of claim 2, wherein determining the one or more settlement parameters further comprises determining, via the computing device processor, the one or more settlement parameters by applying at least one of the settlements rules to the transaction, wherein at least one of the applied settlement rules is associated with a monitored settlement variable.

4. The method of claim 1, wherein receiving the one or more settlement rules further comprises receiving, in the computing device memory, one or more settlement rules associated with the merchant, wherein the settlement rules are received from one of the financial institution or the merchant.

5. The method of claim 1, wherein receiving the one or more settlement rules further comprises receiving, in the computing device memory, a settlement rule associated with a time for settlement.

6. The method of claim 1, wherein receiving the one or more settlement rules further comprises receiving, in the computing device memory, a settlement rule associated with a settlement location.

7. The method of claim 1, wherein receiving the one or more settlement rules further comprises receiving, in the computing device memory, a settlement rule associated with a settlement channel.

8. The method of claim 1, wherein receiving the one or more settlement rules further comprises receiving, in the computing device memory, a settlement rule associated with a transaction product type.

9. The method of claim 1, wherein receiving the one or more settlement rules further comprises receiving, in the computing device memory, a settlement rule associated with transaction type.

10. The method of claim 9, wherein receiving a settlement rule associated with transaction type further comprises receiving, in the computing device memory, a settlement rule associated with one or more of transaction amount, transaction payment type, transaction location, transaction customer type or transaction customer.

11. The method of claim 2, wherein monitoring further comprises monitoring, at a computing device, at least one of the merchant's current financial status, the merchant's current cash flow requirements, the merchant's future cash flow requirements, the merchant's current credit requirements or the merchant's future credit requirements.

12. The method of claim 1, wherein determining one or more settlement parameters further comprises determining, via a computing device processor, one or more settlement parameters, wherein the parameters include at least one of settlement time, settlement location or settlement channel.

13. The method of claim 1, wherein receiving a transaction confirmation further comprises receiving a transaction confirmation associated with a transaction in which the financial institution has authenticated the customer.

14. An apparatus configured for transaction settlement between a financial institution and a merchant, the apparatus comprising:
a computing platform including at least one processor and a memory; and
a merchant settlement application stored in the memory, executable by the processor and configured to include,
a settlement rules routine configured to receive, in computing device memory, one or more settlement rules associated with the merchant,
a settlement parameter determining routine configured to determining one or more settlement parameters by applying at least one of the settlement rules to a transaction involving the merchant, and
a settlement routine configured to settle the transaction with the merchant in accordance with the one or more settlement parameters.

15. The apparatus of claim 14, wherein the merchant settlement application further comprises a merchant settlement variable monitoring routine configured to monitor one or more settlement variables associated with the merchant.

16. The apparatus of claim 15, wherein the settlement parameter determining routine is further configured to determine the one or more settlement parameters by applying at least one of the settlements rules to the transaction, wherein at least one of the applied settlement rules is associated with a monitored settlement variable.

17. The apparatus of claim 14, wherein the settlement rules routine is further configured to receive the one or more settlement rules associated with the merchant, wherein the settlement rules are received from one of the financial institution or the merchant.

18. The apparatus of claim 14, wherein the settlement rules routine is further configured to receive a settlement rule associated with a time for settlement.

19. The apparatus of claim 14, wherein the settlement rules routine is further configured to receive a settlement rule associated with a settlement location.

20. The apparatus of claim 14, wherein the settlement rules routine is further configured to receive a settlement rule associated with a settlement channel.

21. The apparatus of claim 14, wherein the settlement rules routine is further configured to receive a settlement rule associated with a transaction product type.

22. The apparatus of claim 14, wherein the settlement rules routine is further configured to receive a settlement rule associated with transaction type.

23. The apparatus of claim 22, wherein the settlement rules routine is further configured to receive a settlement rule associated with the transaction type, wherein transaction type includes one or more of transaction amount, transaction payment type, transaction location, transaction customer type or transaction customer.

24. The apparatus of claim 15, wherein the merchant settlement variable monitoring routine is further configured to monitor at least one of the merchant's current financial status, the merchant's current cash flow requirements, the merchant's future cash flow requirements, the merchant's current credit requirements or the merchant's future credit requirements.

25. The apparatus of claim 15, wherein the settlement parameter determining routine is further configured to determine one or more settlement parameters, wherein the parameters include at least one of settlement time, settlement location or settlement channel.

26. A computer program product comprising:
a non-transitory computer-readable medium comprising:
a first set of codes for causing a computer to receiving one or more settlement rules associated with the merchant;
a second set of codes for causing a computer to receive a transaction confirmation that indicates that a transaction has occurred involving the merchant;
a third set of codes for causing a computer to determine one or more settlement parameters by applying at least one of the settlement rules to the transaction; and
a fourth set of codes for settling the transaction with the merchant in accordance with the one or more settlement parameters.

27. The computer program product of claim 26, further comprising a fifth set of codes for monitoring one or more settlement variables associated with the merchant.

28. The computer program product of claim 27, wherein the third set of codes is further configured to cause the computer to determine the one or more settlement parameters by applying at least one of the settlements rules to the transaction, wherein at least one of the applied settlement rules is associated with a monitored settlement variable.

29. The computer program product of claim 26, wherein the first set of codes is further configured to cause the computer to receive one or more settlement rules associated with the merchant, wherein the settlement rules are received from one of the financial institution or the merchant.

30. The computer program product of claim 26, wherein the first set of codes is further configured to cause the computer to receive a settlement rule associated with a time for settlement.

31. The computer program product of claim 26, wherein the first set of codes is further configured to cause the computer to receive a settlement rule associated with a settlement location.

32. The computer program product of claim 26, wherein the first set of codes is further configured to cause the computer to receive a settlement rule associated with a settlement channel.

33. The computer program product of claim 26, wherein the first set of codes is further configured to cause the computer to receive a settlement rule associated with a transaction product type.

34. The computer program product of claim 26, wherein the first set of codes is further configured to cause the computer to receive a settlement rule associated with transaction type.

35. The computer program product of claim 34, wherein the first set of codes is further configured to cause the computer to receive a settlement rule associated with one or more of transaction amount, transaction payment type, transaction location, transaction customer type or transaction customer.

36. The computer program product of claim 27, wherein the fifth set of codes is further configured to monitor at least one of the merchant's current financial status, the merchant's current cash flow requirements, the merchant's future cash flow requirements, the merchant's current credit requirements or the merchant's future credit requirements.

37. The computer program product of claim 26, wherein the third set of codes is further configured to cause the computer to determine one or more settlement parameters, wherein the parameters include at least one of settlement time, settlement location or settlement channel.

38. The computer program product of claim 26, wherein the first set of codes is further configured to cause the computer to receive a transaction confirmation associated with a transaction in which the financial institution has authenticated the customer.
